(19) United States
(12) Patent Application Publication
(10) Pub. No.: US 2017/0174086 A1
(43) Pub. Date: Jun. 22, 2017

(54) Home and Vehicle Energy System

(71) Applicant: Red Automotive Technologies Pty Ltd, Thebarton (AU)

(72) Inventor: Paul van de Loo, Norton Summit (AU)

(73) Assignee: Red Automotive Technologies Pty Ltd, Thebarton (AU)

(21) Appl. No.: 15/380,169

(22) Filed: Dec. 15, 2016

(30) Foreign Application Priority Data
Dec. 16, 2015 (AU) 2015905205

(51) Int. Cl. B60L 11/12; F01N 5/02; H02K 7/18; B60L 11/18

(52) U.S. Cl. CPC B60L 11/12; B60L 11/1816; B60L 11/184; F01N 5/02; H02K 7/1815; B60L 2230/10

(57) ABSTRACT

A home and vehicle energy system having an electricity generator that generates electricity from a combustible fuel, a detachable electricity supply conduit for the transfer of electrical energy between the home and the vehicle in at least one direction, a detachable heat supply conduit for the transfer of heat between the electricity generator and the home, a vehicle electricity store that allows the vehicle to sustain motion via its electric drive motors when detached from the home; and

a controller that regulates the generation of electricity by the electricity generator and the flows of heat and electricity.

### RELATED APPLICATION

This application claims convention priority from Australian provisional patent application 2015905205 filed on Dec. 16, 2015. The contents of that application are incorporated herein by reference.

### TECHNICAL FIELD

The present invention relates to a system for providing energy to a vehicle and a home in an efficient and cost effective manner.

### BACKGROUND

Vehicles for transportation of goods and passengers are increasingly propelled purely by one or more electric motors with electricity provided by a battery. These are often called electric vehicles (EV). A well understood issue with EVs is the inability to recharge the battery if the battery becomes exhausted when not in close proximity to a charging point. This problem is more difficult to solve than the situation when a conventional internal combustion engined vehicle runs out of fuel; in this case it is practical to transport some fuel to the stranded vehicle. This issue with electric vehicles is often termed “range anxiety” in reference to the problem posed to the driver when the vehicle becomes stranded. In response to this problem, some vehicles are fitted with range extenders. These are a small engine that power an electricity generator fitted to the vehicle that run on a conventional fuel such as diesel, gasoline, compressed natural gas or liquid petroleum gas (LPG). This generator recharges the battery and/or powers the vehicle's electric drive motor(s) directly. These are a form of what are known as hybrid vehicles, specifically series hybrid vehicles.

Typically the cost of recharging the battery by plugging the vehicle in at a charging point on the electricity grid is cheaper than recharging via the range extender engine using a fuel such as gasoline or diesel. Range extender engines are thus typically used only when necessary, primarily when the vehicle is in motion and the battery is discharged or in a low state of charge. Range extender engines are typically internal combustion engines operating on the Otto cycle (or a variation such as the Miller or Atkinson cycle) or Diesel cycles. However they may be other types of engine such as a gas turbine. Fuel cells have also been proposed for this application but are yet to be commonly offered commercially.

Homes in most climates require space heating during colder times such as winter and at night. Many different types of energy source are used for space heating such as natural gas, biomass or using electricity, often using a heat pump. Homes also almost universally have a means to heat hot water for sanitary use and this often accounts for a substantial portion of a home's energy use. Homes utilising natural gas are generally connected to a reticulated supply. Most homes also use a substantial amount of electricity for lighting, running appliances and for heating and cooling, such as by the use of heat pumps. Electricity is generally supplied from an electricity grid, although many homes now supplement this from solar photovoltaic panels. Some homes also use micro-cogeneration systems (also commonly termed combined heat and power (CHP) systems). These utilise a fuel, typically natural gas from a reticulated supply to power a fuel cell or a heat engine, such as an internal combustion engine, a Rankine cycle engine or a Stirling cycle engine, to drive an electricity generator thereby converting energy in the fuel into heat and electricity. The heat is typically used for space heating and water heating. The electricity is used for household consumption and any excess is typically exported into the grid. Such cogeneration systems are typically very energy efficient, with over 90% of the heating value of the fuel (higher heating value) converted to useful heating or electricity. In an era where saving on energy costs and reduction of greenhouse gas emissions is increasingly important these systems are increasingly popular.

A household that owns a range extended EV and has a cogeneration system fitted to their home thus has two electricity generators such as engine powered generators or fuel cells, one in the EV and one in the house. Typically when the EV is parked at home there is no need to operate both. When the EV is not home there will often be few people in the home and hence a reduced need for energy, thereby limiting demand on the home's cogeneration system. An aim of the present invention is to eliminate the need for two such electricity generators.

The costs of an electricity grid connection to a home can be considerable. Typical electricity utilities charge fixed or standing costs in addition to a charge for the actual energy consumed. Typically also energy sold into the grid by the home owners is sold for a lower price than the utility sells electricity to the household. There is often also a substantial fee for the initial connection of a home to the electricity grid. There is commonly a desire by home owners to be independent of the electricity grid to avoid these costs. It is a further aim of the present invention to enable home energy supply needs to be met without requiring a connection to the electricity grid, or at least to lessen the dependence of the household on grid supplied electricity.

Before turning to a summary of the present invention, it must be appreciated that any description of prior art is provided merely as background to explain the context of the invention. It is not to be taken as an admission that any of the material referred to was published or known, or was a part of the common general knowledge in Australia or elsewhere.

### SUMMARY OF THE INVENTION

The present invention provides a home and vehicle energy system, the system including:

an electricity generator that generates electricity from a combustible fuel and also produces heat, and that is at least temporarily mounted to the vehicle;

a detachable electricity supply conduit for the transfer of electrical energy between the home and the vehicle in at least one direction, the electricity supply conduit being detachable to allow the vehicle to travel away from the home;

a detachable heat supply conduit for the transfer of heat between the electricity generator and the home, the heat supply conduit being detachable to allow the electricity generator to travel away from the home with the vehicle;

a vehicle electricity store that allows the vehicle to sustain motion via its electric drive motors when detached from the home; and

a controller that regulates the generation of electricity by the electricity generator and the flows of heat and electricity;

wherein the controller implements an energy strategy.

The present invention also provides a method of operating a home and vehicle energy system, the method including:

generating electricity and heat from a combustible fuel;

transferring electrical energy between the vehicle and the home in at least one direction;

transferring heat from the electricity generator to the home;

storing of electrical energy in the vehicle in a vehicle electricity store; and

controlling with a controller the generating of electricity and the flows of electricity and heat in accordance with an energy strategy.

In preferred forms of the present invention, the energy strategy is one or more of the minimisation of operating cost, the minimisation of greenhouse gas emissions, and the minimisation of any deficit in supply of heat and electricity relative to vehicle and home demands, or any other energy strategy that could be required by the consumer, regulatory authorities or energy utilities, to meet their objectives. Additionally, where multiple energy strategies are desired to be implemented simultaneously, it is envisaged that suitable weightings may be applied to one or more energy strategy in order to deliver a result that reflects an order of priorities of a user.

The primary functions of both the system and the method of the present invention are the provision of energy to the electric drive motor of a vehicle, and the provision of heating and electricity to a home. The ability to transfer not just electricity but also heat provides for very efficient use of the fuel consumed by the electricity generator. Such co-generation is a particularly efficient use of combustible fuel, often realising overall efficiency, based on gross calorific value of the fuel, well in excess of 90%.

The controller of the present invention may include any type of controller such as a micro-computer, electronic circuit, programmable logic controller (PLC) or the like. In a preferred form, the controller receives information from sensors which may include sensors to ascertain the quantity of energy in the vehicle electricity store, the amount of heating required in the home, the current electrical load in the home and the amount of fuel available to the electricity generator. In this preferred form, the controller may also accept other inputs such as the monetary cost of fuel supplied.

In one form of the invention, the controller is located in the home and communicates with sensors in the home and the vehicle. The controller preferably controls when and to what magnitude the electricity generator generates electricity and whether this is directed to charging of the vehicle electricity store, or is directed to the home via the electricity supply conduit, or is directed to consumers of electricity in the vehicle such as vehicle occupant seat heaters or windscreen demisters. The controller may also control when and to what magnitude heat is supplied from the electricity generator to the home. In another form of the invention the home may also have an electricity store. In this case the controller may also control how much electricity to direct to the home electricity store. In this case, the term “home electricity demands” used in this specification can be taken to include the charging demands of the home electricity store.

In another form of the invention, the controller is located in the vehicle and communicates with sensors in the home and the vehicle.

In yet another form of the invention, there are separate controllers, one located in the vehicle and one in the home, which communicate with each other and collaborate to perform the overall control function, where that function is to implement one or more control strategies. In this respect, a controller (whether in the vehicle or the home or both) may be configured so as to be able to communicate with another controller and/or with sensors remotely, such as via an internet connection, or in the case of the vehicle via a wireless connection.

The controller may also communicate either directly or indirectly with a user, to accept information from the user or to provide information to the user, or both. Information provided by the user may include user preference on the overall controller strategy or specific information such as the anticipated next time, duration and travel distance of vehicle travel from the home. This can then be used by the controller to plan the amount of charging of the vehicle and home electricity stores and the amount of heating to be supplied to the home.

It will be appreciated that there are many different strategies that the controller of the present invention can implement. One strategy is to minimise the financial cost to the user of the provision of energy to the home and vehicle. In a simple form, this strategy could involve choosing whether to operate the electricity generator on natural gas from a reticulated supply to the home, or from fuel stored in the vehicle, depending on the relative costs of using these fuels.

In another form of the invention, the home may also be connected to the electricity grid. In this form, with the cost of grid supplied electricity varying depending on the time of day, the controller preferably decides whether to supply the home electricity demand and vehicle electricity store charging demands from grid electricity or electricity from the electricity generator. In this form, the controller preferably also decides to defer supplying electricity to non-urgent electricity loads, such as and home electricity store charging, until grid electricity pricing is low, and then perform this charging with electricity from the grid. It may also defer electricity generation until there is a heat load in the home that must be met and would otherwise be met by other sources which cost money.

These types of strategies will work to minimise the cost of operation of the system. In this context, the term “minimise the cost” means to reduce the cost as much as is practical based on the knowledge available to the controller at the time and the constraints under which the system operates. It is not taken to mean the absolute lowest cost that could be achieved; such as if the controller had additional information available to it, or its operation could be changed with the benefit of hindsight.

In yet another form of the invention, the home may have solar photovoltaic electricity generating panels installed. In this form, the controller preferably receives weather forecast data via the internet which it can use to predict the amount of electricity that the solar photovoltaic panels will generate in the immediate future. The controller may then assess or calculate other information such as the amount of energy stored in the vehicle and home electricity stores, likely vehicle energy requirements for the immediate future based on past operating patterns or user input, and likely home electricity requirements, and then decide whether it should supply electricity by operating the electricity generator.

An alternative strategy that the controller of the present invention may execute is the minimisation of greenhouse gases. In this context, greenhouse gases are primarily the emission of carbon dioxide (CO₂), although there are other gases associated with the greenhouse effect, such as methane. However, the greenhouse effect is often referred to by reference to an equivalent amount of CO₂, being a CO₂ equivalent or simply CO₂e. The consumption of fuel by the electricity generator will lead to the emission of a known quantity of CO₂e. The purchase of electricity from the grid also has a known quantity of CO₂e emissions associated with it. Sources of home heating other than the heat supplied from the electricity generator will also have known CO₂e emissions.

In a preferred form, the controller thus preferably acts to supply home heating or home electricity demands, and vehicle electricity store charging demands, with the energy source with the lowest CO₂e emissions associated with it. This could mean for example that the supply of heat to a home hot water storage tank is deferred by the controller until the vehicle returns home, so that the heat from the electricity generator can be used for this, whilst the electricity from the electricity generator is used to recharge the vehicle electricity store or other demand for electricity. In this form, the controller would have calculated that this produces lower total CO₂e emissions than meeting the hot water heating demand and electricity demands in any other available way. In this instance, information provided to the controller on likely arrival time of the vehicle to the home may also be key to the decision making process by the controller. Such arrival time information may be communicated to the controller wirelessly, via the internet, or estimated from past behaviours that are available to the controller, or a combination of all of these.

In the cost and greenhouse gas minimisation strategies, the controller preferably also seeks to defer operating the electricity generator, and maximise the generation of electricity by solar photovoltaic panels, as this electricity is free both in terms of financial cost and CO₂e emissions.

In the discussion above on controller strategy to minimise greenhouse gas emissions, the term “minimise greenhouse gas emissions” means to reduce the total emissions associated with the system as much as is practical based on the knowledge available to the controller at the time and the constraints under which the system operates. It is not taken to mean the absolute lowest emissions that could be achieved, such as if the controller had additional information available to it, or its operation could be changed with the benefit of hindsight.

The electricity generator of the present invention can include any manner of device that consumes a combustible fuel to produce electricity, and includes devices such as a fuel cell, an internal combustion engine driving an alternator and a Stirling cycle engine driving an alternator. The electricity produced by the electricity generator may be in several different formats, such as alternating current (AC), in one or multiple phases, or direct current (DC), and at any voltage level.

Similarly the transfer of electrical energy between the vehicle and the home can occur in any format, and the format may be different to that produced by the generator. Such a change in format may be produced by a suitable converter, as are well understood by those skilled in the art, and may be done for reasons of convenience, such as minimisation of the size of electrical conductors, or for safety, such as a reduction in voltage.

The electricity supply conduit of the present invention facilitates this transfer of the electricity between the home and the vehicle of the present invention and can take the form of wires, cables or other conductors known to those skilled in the art. It may also be done without the aid of wires or conductors for some or all of the length of the conduit. Such wireless transfer may be an inductive or capacitive transfer of electricity in the form of alternating current. Indeed, a wireless link in the electricity supply conduit configured to provide inductive or capacitive transfer of electricity may provide the ability to detach the electricity supply conduit between the vehicle and the home. Alternatively, the detachment of the electricity supply conduit in the present invention may be provided by a more conventional electrical connector such as one comprised of a plug and a socket with mechanically mating pins and receptacles.

It should be noted that the term “conduit” in the context of the present invention is used in its broadest sense, that is, a means by which something is transmitted. Indeed, it may include a means such as a pipe to carry a liquid, but can also include a means that has no material form, such as a means for the transmission of radio signals. There is also no distinction between the singular and the plural; in a case where transmission requires transfer in more than one direction to effect transmission, or more than one transfer path is required, this may also be referred to as a conduit in the singular.

The combustible fuel that is consumed by the electricity generator of the present invention may be one or more of fuels such as hydrogen, gasoline, ethanol, diesel, natural gas, liquid petroleum gas, and butane. The fuel may be supplied to the electricity generator from storage on the vehicle, or a home source, or both. A home fuel source may be a fuel storage vessel that is periodically refilled (in some embodiments by replenishment from fuel stored on the vehicle) or it may be a reticulated supply, such as a natural gas supply main. In this respect, it is envisaged that in one form of the invention a controller can be configured to control fuel flow between (to and from) the vehicle fuel storage and the home fuel storage, including via a reticulated supply, in order to control fuel storage levels in both, depending upon existing levels, desired levels, actual and predicted usage, and fuel cost, and the like.

In one form of the present invention, the electricity generator may be a part of the vehicle, but be removable from the vehicle and connectable to the home, such as for the purpose of supplying electricity to the home when the vehicle travels away from the home. In this form of the present invention, the fuel supply to the electricity generator may also be a fuel storage vessel located with the electricity generator.

The detachable heat supply conduit of the present invention can take a number of forms. In one form, the electricity generator produces hot exhaust gas and the heat supply conduit includes a pipe that transports the hot gas to the home where the heat can be extracted from the gas prior to the gas being discharged to atmosphere. Preferably the pipe has a connector, such as a screw coupling, at its interface to the vehicle which can be readily detached allowing the vehicle to travel away from the home.

In another form, the heat supply conduit is a pair of pipes that allow a liquid, or a liquid-vapour mixture, to flow from the electricity generator to the home, where heat can be extracted from it before returning to the electricity generator where additional heat energy can then be introduced to it. This is commonly referred to as a “closed loop” system. Both pipes of this pair preferably include a feature allowing them to be detached so as to allow the vehicle to travel away from the home. These may take the form of quick-disconnect couplings that provide quick and convenient detachment while preventing fluid from escaping from the detached pipe ends.

In another form, the heat supply conduit may be a hose having a high degree of flexing such as may be required to adapt for variation in spatial position of the vehicle when connecting to the home.

In yet another form, the heat supply conduit includes a combination of different conduits; one to transfer hot fluid from which heat is extracted at the house before being discharged to atmosphere, and one or more pairs of conduits configured as closed loop heat transfer systems as described previously.

The above references to the vehicle and home electricity stores of the present invention can include any type of electrochemical cell, or number of electrochemical cells electrically arranged in series, parallel or a combination thereof to form a battery. The electrochemical cells may use a number of different chemical combinations, such as those commonly referred to as lithium ion cells, nickel metal hydride cells, lead acid cells, and the like. In another form of the present invention, the vehicle and home electricity stores may be a super capacitor; a capacitor that can store electrical energy with small losses over extended periods of time. In yet another form, the vehicle and home electricity stores may be a flow battery where electrical potential is developed between two liquid electrolyte streams.

### BRIEF DESCRIPTION OF DRAWINGS

Having briefly described the general concepts involved with the present invention, several preferred embodiments of the present invention will now be described. However, it is to be understood that the following description is not to limit the generality of the above description.

In the drawings:

FIG. 1 is a schematic diagram according to a preferred embodiment of the present invention;

FIG. 2 is a schematic diagram according to a second preferred embodiment of the present invention;

FIG. 3 is a schematic diagram according to a third preferred embodiment of the present invention;

FIG. 4 is a schematic diagram according to a fourth preferred embodiment of the present invention;

FIG. 5 is a schematic diagram according to a fifth preferred embodiment of the present invention;

FIGS. 6a, 6b, 6c, and 6d are schematic diagrams according to a sixth preferred embodiment of the present invention.

### DETAILED DESCRIPTION OF PREFERRED EMBODIMENTS

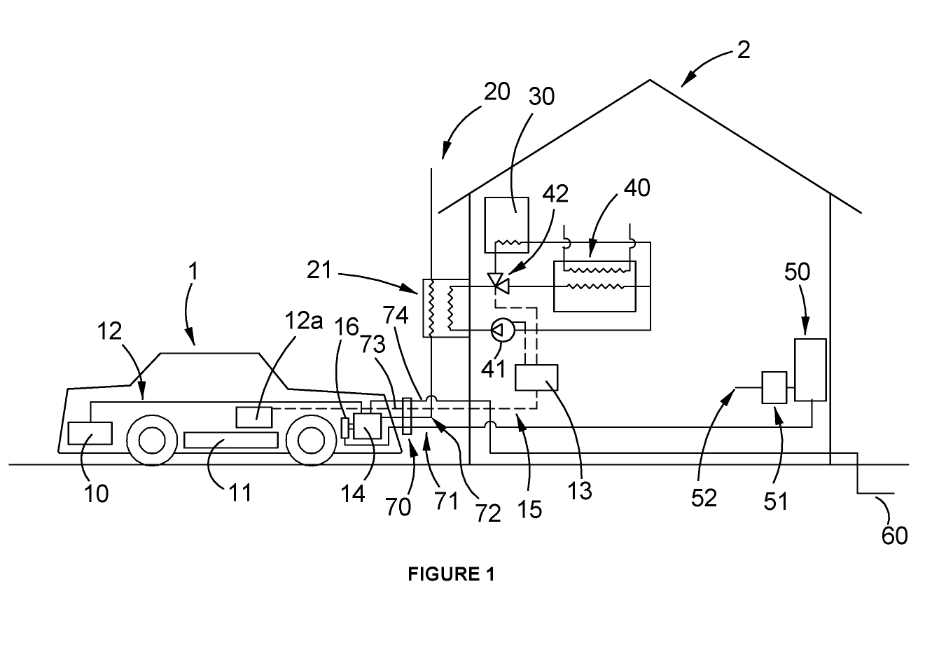

Referring to FIG. 1, the first embodiment of the present invention includes a vehicle 1 and a home 2 to which the vehicle 1 can be connected via a connector 70. The connector 70 allows conduits between the home 2 and the vehicle 1 to be connected, including a conduit for exhaust gas 72, electricity 71, control signals 73 and combustible fuel 74. The connector 70 provides suitable connections such as electrical plugs and mating sockets for electrical conduits such as electricity supply conduit 71 and control signal conduit 73. It also provides suitable connections for fluid conduits such as the combustible fuel conduit 74.

For fluids where the loss or spillage of fluid is undesirable on disconnection, these connections may take the form of “quick disconnect coupling” connector pairs that incorporate spring loaded valves that seal the conduit on each side. These are well known to those skilled in the art. When conduits are disconnected at connector 70, connector 70 splits into two mating parts or pairs characterised by mating connections for each conduit on either part. In another form, the connector 70 may be several separate connector pairs rather than one combined set of connector pairs.

Still referring to FIG. 1, the vehicle 1 contains a fuel tank 10 for the storage of combustible fuel which is supplied via a fuel supply conduit 12 to a heat engine 14. The heat engine 14 is an internal combustion engine such as an engine operating on the Otto cycle, Diesel cycle, Miller cycle or Atkinson cycle. In another form, the heat engine 14 may be an external combustion engine such as a gas turbine or an engine operating on the Rankine or Stirling cycle.

The heat engine 14 provides mechanical energy to an alternator 16 which generates electricity—together these comprise an electricity generator. As mentioned above, the electricity generator may alternatively take the form of a fuel cell which converts chemical energy in the fuel directly to electricity, avoiding the intervening step of mechanical energy.

The alternator 16 can provide electricity, after first being suitably converted, such as by a rectifier (not shown) from AC to DC, to a vehicle electricity store in the form of a vehicle battery 11 in the vehicle 1 via a conduit (not shown), and to the home 2 via the electricity supply conduit 71. The vehicle battery 11 can be any type of electrochemical cell such as lithium ion, lead-acid or nickel metal hydride. Alternatively, the vehicle battery 11 may be a supercapacitor.

The heat engine 14 produces exhaust gas which contains a significant amount of heat energy. This exhaust gas travels through the heat supply conduit 72 to a heat exchanger 21 at the home 2, where the heat exchanger 21 transfers heat to a fluid circuit where a fluid is circulated by a pump 41. The fluid can transport heat to a hot water storage tank 30 and to a space heating system 40.

The amount of heat provided to the hot water storage tank 30 and the space heating system 40 depends on the position of the valve 42, which is controlled by a home controller 13 in response to demands for heat by the space heating system 40 and the hot water storage tank 30. This may be communicated to the home controller 13 by sensors or thermostats as are well known by those skilled in the art (not shown in the figure). The cooled exhaust gas is emitted to atmosphere through a flue 20. The heat supply conduit 72 may be a hose or a pipe suitable for operation at high temperatures, and preferably has a sheath of material providing good resistance to heat loss from the conduit 72.

Electricity supplied to the home 2 from the vehicle 1 via the electricity supply conduit 71 may be stored in a home electricity store such as a home battery 50. The conduit 71 may be a cable with a conductive core made of a material such as copper or aluminium and a sheath of material that provides high electrical resistance. Electricity from the home battery 50 may then be used in the home 2 after passing through an inverter 51 to convert it to the typically desired alternating current (AC) format. The home battery 50 may be any type of electrochemical cell such as lithium ion, lead-acid or nickel metal hydride. Alternatively the home battery 50 may be a supercapacitor.

Whilst the vehicle 1 is attached to the home 2 via the connector 70, the heat engine 14 can be operated with fuel from the vehicle fuel tank 10 or from the home fuel supply which enters the home at a connection point 60 and flows to the vehicle 1 via the conduit 74. In a preferred form, the vehicle fuel tank 10 is used to store gasoline or diesel fuel, the fuel supplied via the connection point 60 is natural gas and the heat engine 14 is configured such that it can operate on either fuel.

As mentioned previously, in another form, the electricity generator takes the form of a fuel cell. In this form, the fuel stored in the vehicle tank 10 may be hydrogen and may be refilled at dispensers to which the vehicle 1 may travel from time to time. In this form, the fuel supplied to the home 2 via the connection 60 may be natural gas that is reformed to hydrogen by a suitable reformer located in the home 2 or the vehicle 1 (not shown), enabling the fuel cell to operate from either the vehicle fuel supply or the home fuel supply.

When the vehicle 1 is connected to the home 2 this is communicated to a vehicle controller 12a and the home controller 13 by a communication link 15 and a sensor (not shown). The communication link 15 may take the form of a wired or wireless link. The controllers 12a,13 will then jointly determine whether the heat engine 14 should be operated to satisfy energy needs in the vehicle 1 or the home 2. These needs may include one or more of the need to recharge the vehicle battery 11, the need to heat water in the hot water storage tank 30, the need to charge the home battery 50, and the need to provide space heating in the home 2.

The choice of fuel to use between fuel from the tank 10 or fuel from the connection point 60 is determined by the vehicle controller 12a, typically in conjunction with the home controller 13. The controllers 12a,13 would determine which fuel to use based on parameters including one or more of, but not limited to, user preference, relative costs of the fuels, greenhouse gas emissions generated by use of the alternative fuels, and the amount of fuel remaining in fuel tank 10. User preference may be input to the controller 12a or the controller 13 via a suitable user interface (not shown) and via suitable communication means such as wires, radio connection or the internet. Similarly, user preferences or other inputs such as desired home space temperature, desired charge levels in the vehicle battery 10 and the home battery 50 may also be communicated to the controllers.

When the vehicle 1 is detached from the home 2 by disconnecting the connector 70, the vehicle 1 can travel under the influence of its electric drive motor (not shown) with energy provided by the vehicle battery 11. If there is insufficient charge in the vehicle battery 11, the heat engine 14 can be operated using fuel from the fuel tank 10. In this case, the heat may be used for heating the occupant space or vehicle systems, such as the vehicle battery 11 if it is cold, or rejected to the atmosphere. The exhaust gas from the heat engine 14 is emitted to atmosphere via a suitable outlet (not shown).

When the vehicle 1 is detached from the home 2, electricity supply in the home may be maintained by supply from the home battery 50 via the inverter 51.

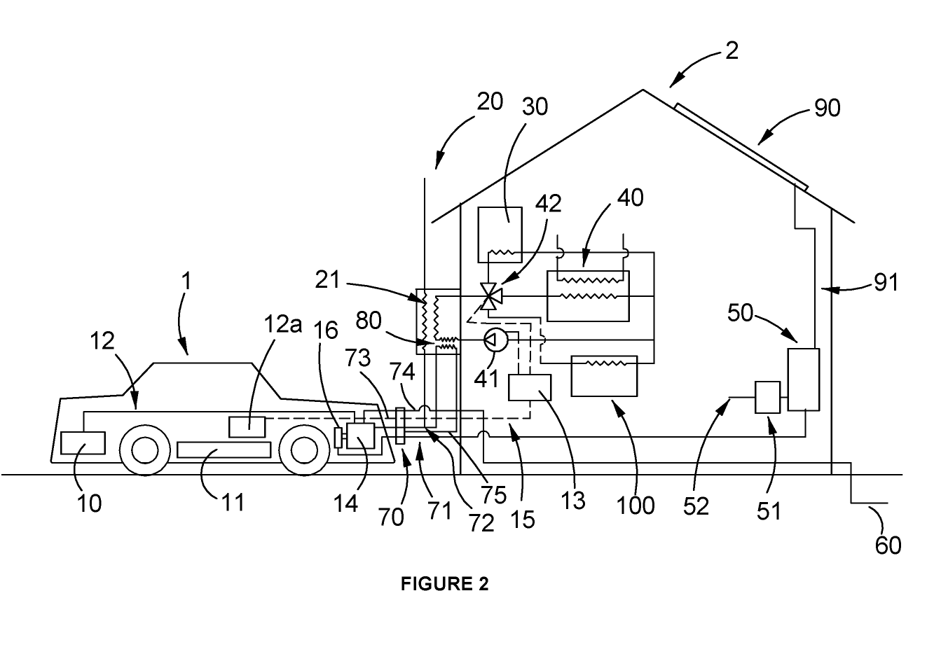

A second preferred embodiment is shown in FIG. 2. This embodiment is similar to the first embodiment (and thus uses the same reference numerals for similar aspects) but differs in that it has additional heat transfer conduits between the vehicle 1 and the home 2 to provide a fluid circuit 75 which transfers heat from the heat engine 14 to the home 2 via a heat exchanger 80.

The fluid circuit 75 of the second embodiment can transfer heat from the cooling jacket of the heat engine 14 and would typically use a pump normally incorporated within the heat engine cooling system of the heat engine 14 to circulate fluid through the circuit 75.

The second preferred embodiment also includes a heat store 100 in the home 2. The valve 42 can direct heat to this heat store 100 to store heat for later use. The heat store 100 incorporates means (not shown) to transfer heat to the home space heating system 40 or to the hot water storage 30 when required. This ensures that heating can be provided to the home 2 when the vehicle 1 is detached from the home 2 by disconnection at the connector 70. The heat store 100 may contain a substance with high specific heat capacity, or a phase change material that provides for a large amount of heat storage with minimal temperature variation.

The second preferred embodiment also includes a photovoltaic solar panel 90 to generate electricity. This electricity may be used directly in the home 2 via the inverter 51 or stored in the home battery 50. This electricity may also be transferred to the vehicle 1 via the conduit 71 to recharge the vehicle battery 11.

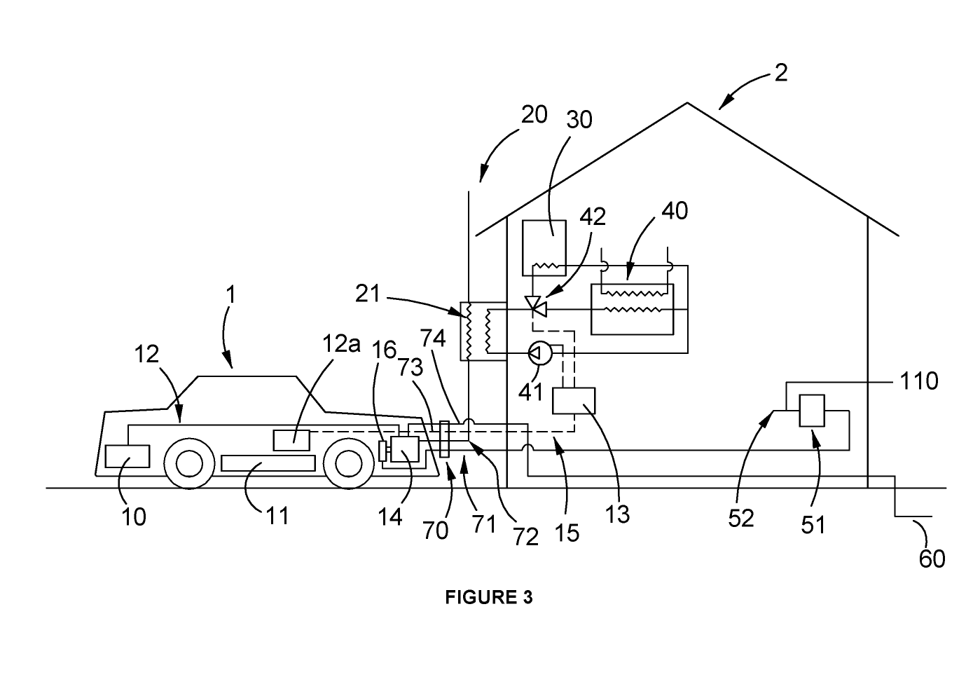

A third preferred embodiment is shown in FIG. 3. This embodiment is similar to the first embodiment (and thus uses the same reference numerals for similar aspects) but differs in that the home 2 is attached to an electricity grid via a connection 110. This connection 110 supplies electricity to the home 2 when the vehicle 1 is detached, or when the alternator 16 is not delivering sufficient electricity to meet demand in the home 2.

In this third embodiment, the home battery 50, as used in the first two embodiments, is not used due to the provision of electricity from the grid connection 110 obviating the need for it. However, in another form, the home battery 50 can still be fitted in conjunction with a grid connection 110, which would enable storage of grid electricity at opportune times such as times of the day when grid electricity is cheap. Electricity from the grid connection 110 or the home battery 50 can be used to supply electricity to the vehicle 2 via the conduit 71 to recharge the vehicle battery 11.

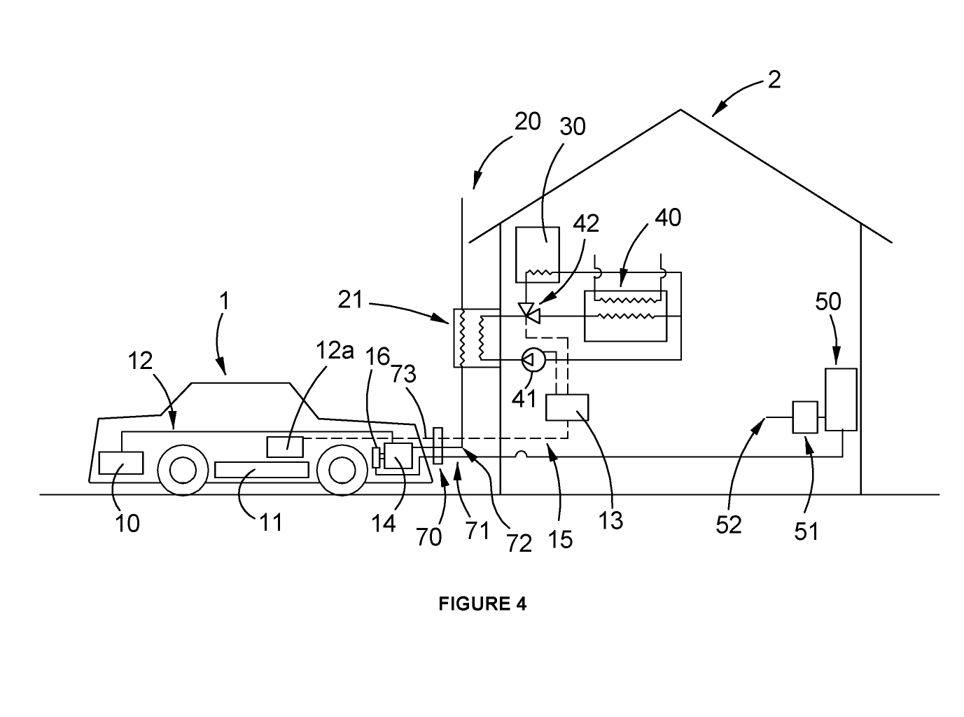

A fourth preferred embodiment is shown in FIG. 4. This embodiment is similar to the first embodiment (and thus again uses the same reference numerals for similar aspects) but differs in that the home 2 does not have a dedicated fuel supply (shown as line 60 in other embodiments). All fuel for the operation of the heat engine 14 is supplied from the vehicle fuel storage tank 10. In cases where the home 2 requires fuel for purposes such as cooking, in this embodiment this fuel may be supplied via a suitable conduit (not shown) via the connector 70 from the vehicle fuel tank 10.

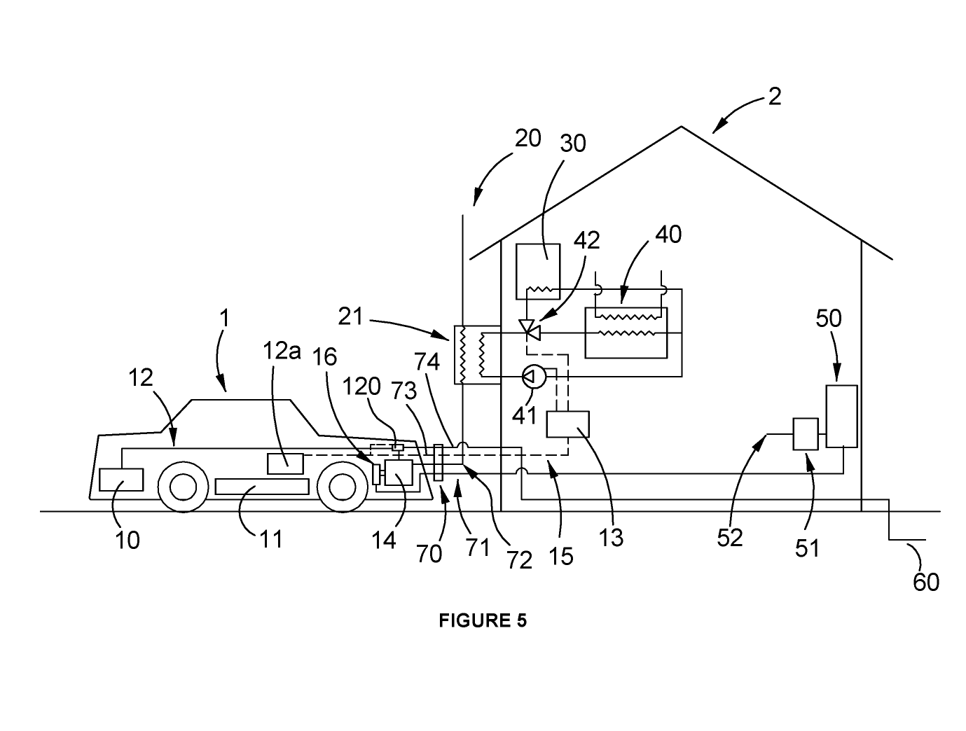

A fifth preferred embodiment is shown in FIG. 5. This embodiment is similar to the first embodiment (and thus uses the same reference numerals for similar aspects) but differs in that the vehicle 1 incorporates a fuel switching valve 120. This valve 120 enables fuel to be directed from the home 2 to the vehicle 1 fuel storage tank 10 as well as to the heat engine 14. The valve 120 also allows fuel to be directed from the fuel tank 10 to the heat engine 14.

The addition of this valve 120 allows the vehicle's fuel tank 10 to be refilled from the home fuel supply, supplied via the connection 60. This may be desirable for the user if the cost of obtaining fuel from a reticulated home supply is lower than that which is readily available for conventional refuelling of vehicles. The fuel switching valve would ideally be controlled by the controller 12a in response to parameters such as user demand, cost of fuel and the quantity of fuel in the tank 10.

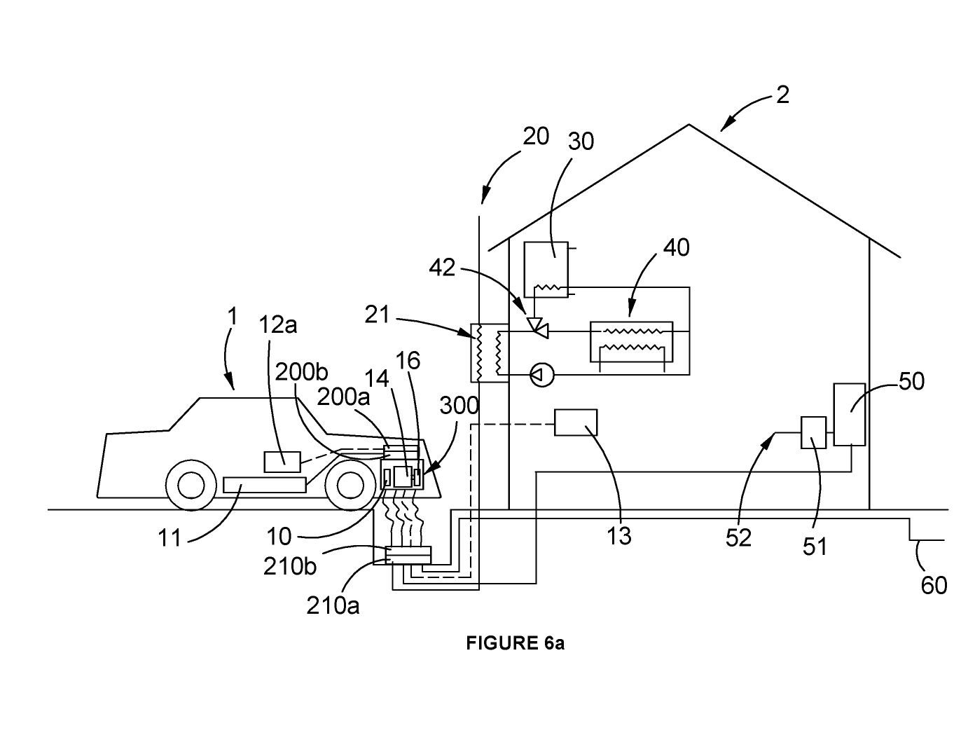

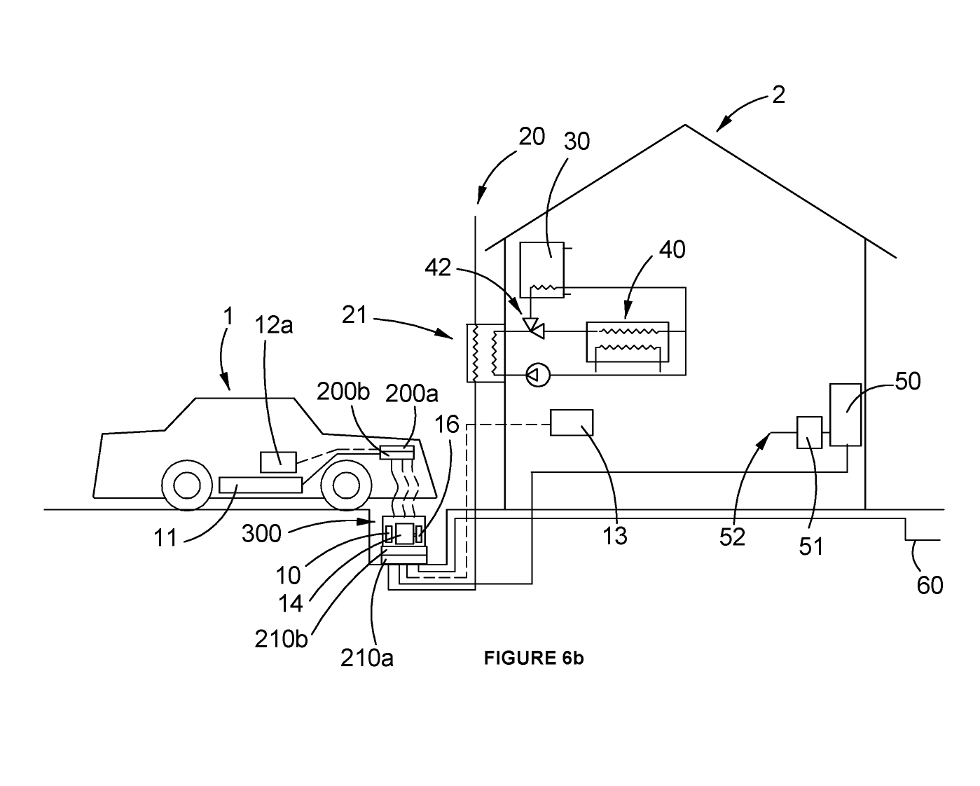

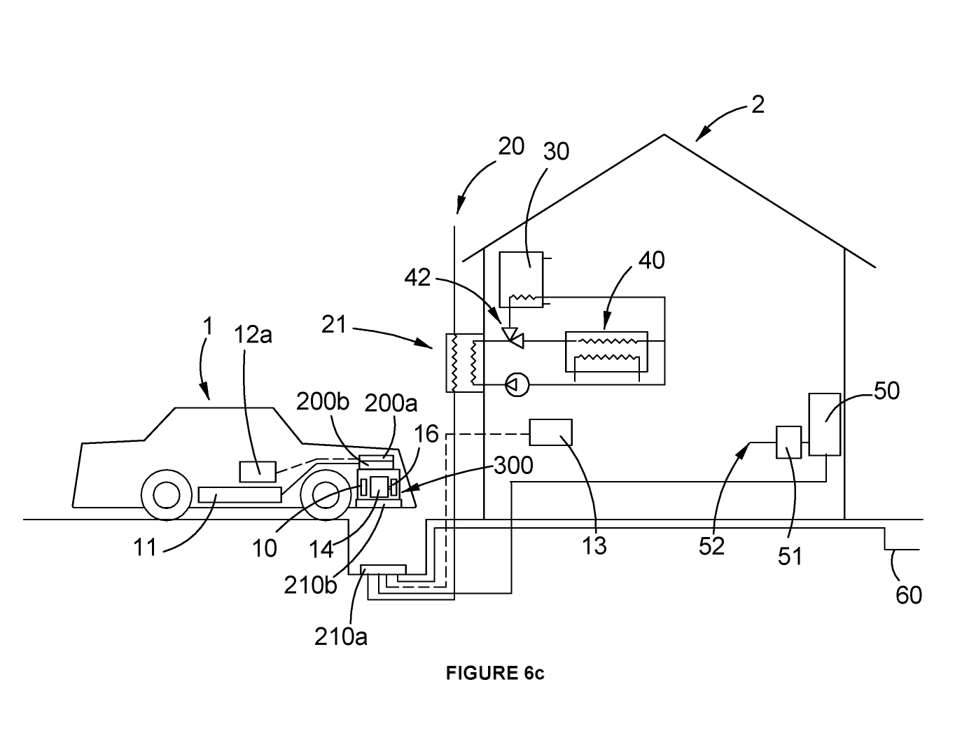

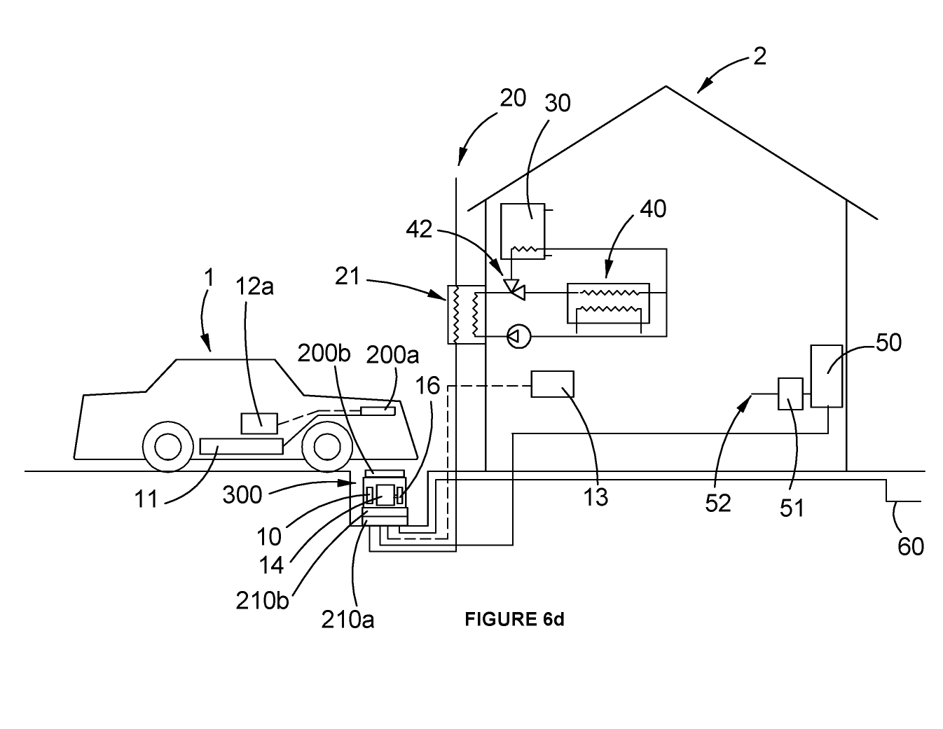

A sixth preferred embodiment is shown in FIGS. 6a, 6b, 6c and 6d. This embodiment is similar to the first embodiment (and thus uses the same reference numerals for similar aspects) but differs in that the electricity generator, here comprised of a module 300 containing the heat engine 14, the alternator 16 and the fuel tank 10, can be transferred between the home 2 and the vehicle 1.

On occasions such as when the user wishes to use a vehicle for a short trip for which the charge in the vehicle battery will be sufficient, or other charging means are available, and the user also wishes to maintain heating to a home, the module 300 can be removed from the vehicle 1 and docked to the home 2. The module 300 is shown in the home docked position in FIGS. 6b and 6d. Whilst the module 300 is docked to the home 2, the heat engine 14 can operate on fuel from the fuel tank 10 or from the home fuel supply supplied via the connection 60.

FIG. 6a shows the sixth embodiment of the present invention with the module 300 docked to the vehicle 1 and connected to the home 2 via connector pair halves 210a and 210b. The connector pair halves 210a/210b connect conduits to carry electricity, heat, fuel and control signals (not numbered in this diagram) similar to those shown in previous embodiments. When the user wants to use the vehicle 1 to travel away from the home 2 and desires to have the electricity generator on board, such as to have additional range than that provided by the charge stored in the vehicle battery 11, the connector half 210b is disconnected from the connector half 210a and retracted into the vehicle 1 as shown in FIG. 6c. The vehicle 1 is then in a state ready to travel away from the home 2.

Should the user desire to make a trip away from the home 2 using the vehicle 1 and does not desire to take the range extending capability of the module 300, the module 300 can be docked to the home as shown in FIG. 6b. This figure shows conduits for the transfer of electricity and control signal connected between the module 300 and the vehicle 1 (not numbered in this diagram) similar to those shown in previous embodiments. This allows transfer of electricity between the module 300 and the vehicle 1 such as to recharge the vehicle battery 11 from the module 300 or to supply electricity from the vehicle battery 11 to the home 2.

When the user decides to travel away from the home 2, the connector halves 200a and 200b are separated and the connector half 200b is retracted to the module 300 as shown in FIG. 6d. The vehicle 1 is then in a state ready to travel away from the home 2.

The module 300 may take several forms including a package that inserts into a cavity or otherwise affixes to the vehicle 1, or alternatively in the form of a trailer (not shown) that is towed behind the vehicle 1 and can be detached when docked to the home 2.

Finally, there may be other variations and modifications made to the configurations described herein that are also within the scope of the present invention.

1. A home and vehicle energy system, the system including:
an electricity generator that generates electricity from a combustible fuel and also produces heat, and that is at least temporarily mounted to the vehicle;
a detachable electricity supply conduit for the transfer of electrical energy between the home and the vehicle in at least one direction, the electricity supply conduit being detachable to allow the vehicle to travel away from the home;
a detachable heat supply conduit for the transfer of heat between the electricity generator and the home, the heat supply conduit being detachable to allow the electricity generator to travel away from the home with the vehicle;
a vehicle electricity store that allows the vehicle to sustain motion via its electric drive motors when detached from the home; and
a controller that regulates the generation of electricity by the electricity generator and the flows of heat and electricity;
wherein the controller implements an energy strategy.

2. A system according to claim 1, wherein the energy strategy is one or more of the minimisation of operating cost, the minimisation of greenhouse gas emissions, and the minimisation of any deficit in supply of heat and electricity relative to vehicle and home demands, or any other energy strategy that could be required by the consumer, regulatory authorities or energy utilities, to meet their objectives.

3. A system according to claim 2 wherein, where multiple energy strategies are desired to be implemented simultaneously, weightings are applied to one or more energy strategy in order to deliver a result that reflects an order of priorities of a user.

4. A system according to claim 1, wherein the controller receives information from sensors, including one or more of sensors to ascertain the quantity of energy in the vehicle electricity store, the amount of heating required in the home, the current electrical demand in the home and the amount of fuel available to the electricity generator.

5. A system according to claim 4, wherein the controller also receives information regarding the monetary cost of fuel supplied.

6. A system according to claim 1, wherein the controller is located in the home and communicates with sensors in the home and the vehicle.

7. A system according to claim 1, wherein the controller is located in the vehicle and communicates with sensors in the home and the vehicle.

8. A system according to claim 1, wherein one controller is located in the vehicle and one controller is located in the home, the controllers communicating with each other and collaborating to perform an overall control function, where that overall control function is to implement one or more control strategies.

9. A system according to claim 6, wherein a controller controls when and to what magnitude the electricity generator generates electricity and whether this is directed to charging of the vehicle electricity store, or is directed to the home via the electricity supply conduit, or is directed to consumers of electricity in the vehicle such as vehicle occupant seat heaters or windscreen demisters.

10. A system according to claim 9, wherein a controller also controls when and to what magnitude heat is supplied from the electricity generator to the home.

11.-26. (canceled)

27. A method of operating a home and vehicle energy system, the method including:
generating electricity and heat from a combustible fuel;
transferring electrical energy between the vehicle and the home in at least one direction;
transferring heat from the electricity generator to the home;
storing electrical energy in the vehicle in a vehicle electricity store; and
controlling with a controller the generating of electricity and the flows of electricity and heat in accordance with an energy strategy.

28. A method according to claim 27, wherein the energy strategy is one or more of the minimisation of operating cost, the minimisation of greenhouse gas emissions, and the minimisation of any deficit in supply of heat and electricity relative to vehicle and home demands, or any other energy strategy that could be required by the consumer, regulatory authorities or energy utilities, to meet their objectives.

29. A method according to claim 28 wherein, where multiple energy strategies are desired to be implemented simultaneously, weightings are applied to one or more energy strategy in order to deliver a result that reflects an order of priorities of a user

30. A method according to claim 27, including the controller receiving information from sensors to ascertain the quantity of energy in the vehicle electricity store, the amount of heating required in the home, the current electrical load in the home, and/or the amount of fuel available to the electricity generator.

31. A method according to claim 30, also including the controller receiving information regarding the monetary cost of fuel supplied.

32. A method according to claim 27, wherein the controller is located in the home and communicates with sensors in the home and the vehicle.

33. A method according to claim 27, wherein the controller is located in the vehicle and communicates with sensors in the home and the vehicle.

34. A method according to claim 27, wherein one controller is located in the vehicle and one controller is located in the home, the controllers communicating with each other and collaborating to perform an overall control function, where that overall control function is to implement one or more control strategies.

35. A method according to claim 32, including controlling when and to what magnitude the electricity generator generates electricity and whether this is directed to charging of the vehicle electricity store, or is directed to the home via the electricity supply conduit, or is directed to consumers of electricity in the vehicle such as vehicle occupant seat heaters or windscreen demisters.

36. A method according to claim 35, including controlling when and to what magnitude heat is supplied from the electricity generator to the home.

37.-49. (canceled)
